(19) United States
(12) Patent Application Publication
(10) Pub. No.: US 2026/0236309 A1
(43) Pub. Date: Aug. 13, 2026

(54) TASK EXECUTION AND RESOURCE MANAGEMENT

(71) Applicant: Bytedance Technology Ltd., Grand Cayman (KY)

(72) Inventors: Jeremiah Duncan, Los Angeles, CA (US); Chunpong Lai, Los Angeles, CA (US)

(21) Appl. No.: 19/053,098

(22) Filed: Feb. 13, 2025

(51) Int. Cl. G06F 9/50

(52) U.S. Cl. CPC G06F 9/5038; G06F 9/5044; G06F 9/5088

(57) ABSTRACT

Described herein are techniques for improving task execution and resource management. A plurality of tasks may be received. The plurality of tasks may be associated with a plurality of workflows. Each workflow comprises a plurality of nodes. A plurality of management components may be created. Each management component corresponds to a particular node. A first node and a second node for execution of a task among the plurality of tasks are determined based on a corresponding workflow. Execution of a first part of the task can be managed by a first management component corresponding to the first node. The task is transferred to a second management component corresponding to the second node for execution of a second part of the task in response to determining that the first part of the task has been completed by the first node.

### BACKGROUND

Complex computing tasks can be expensive and time-consuming to perform. Further, the computing resources available to perform such tasks can be limited. As such, improved techniques for task execution are needed.

### BRIEF DESCRIPTION OF THE DRAWINGS

The following detailed description can be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing asynchronous task execution and resource management in accordance with the present disclosure.

FIG. 2 shows an example system for implementing asynchronous task execution and resource management in accordance with the present disclosure.

FIG. 3 shows an example workflow in accordance with the present disclosure.

FIGS. 4A-4E shows an example specialized queue in accordance with the present disclosure.

FIG. 5 shows an example process for implementing asynchronous task execution and resource management in accordance with the present disclosure.

FIG. 6 shows an example process for creating specialized queues in accordance with the present disclosure.

FIG. 7 shows an example process for implementing asynchronous task execution in accordance with the present disclosure.

FIG. 8 shows an example process for implementing asynchronous task execution in accordance with the present disclosure.

FIG. 9 shows an example process for implementing asynchronous task execution and resource management in accordance with the present disclosure.

FIG. 10 shows an example process for implementing asynchronous task and resource management in accordance with the present disclosure.

FIG. 11 shows an example process for implementing resource management in accordance with the present disclosure.

FIG. 12 shows an example computing device which can be used to perform any of the techniques disclosed herein.

### DETAILED DESCRIPTION OF ILLUSTRATIVE EMBODIMENTS

Complex computational tasks, such as artificial intelligence generated content (AIGC) stylization tasks, are computationally expensive. Such tasks can require large amounts of graphics processing units (GPUs) and GPU hours. This can be especially problematic given limited GPU availability. As such, techniques for improving task execution and resource management are needed. Described herein are techniques for improving task execution that account for task prioritization, retrying, and time limits. Further, described herein are techniques for improving resource management that facilitate automatic resource scaling based on task load.

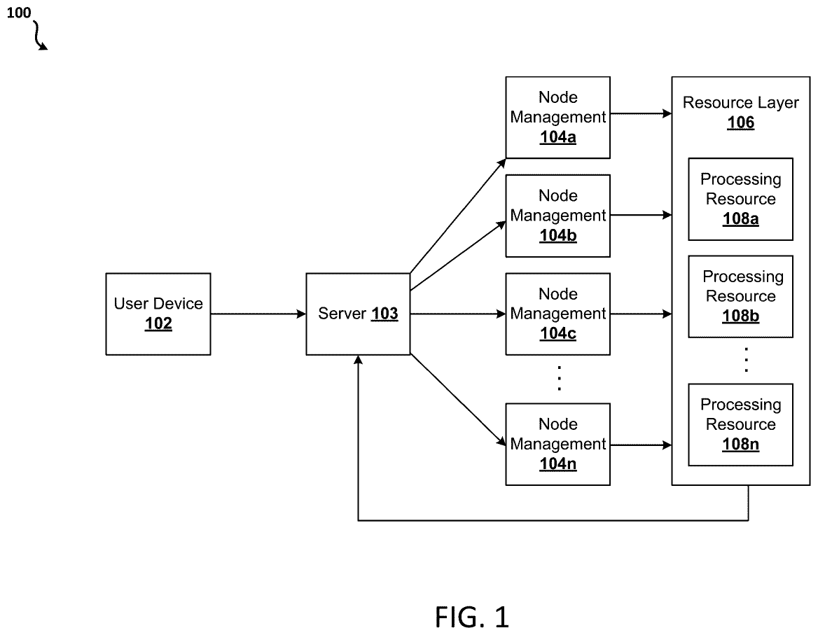

FIG. 1 shows an example system 100 for asynchronous task execution and resource management. The system 100 can include user device(s) 102, a server 103, a plurality of node management components 104a-n (collectively, 104), and a resource layer 106. The resource layer 106 can include a plurality of processing resources 108a-n (collectively, 108). Each of the plurality of processing resources 108a-n can include a central processing unit (CPU) or a GPU.

The user device(s) 102, the server 103, the node management components 104, and the resource layer 106 can communicate with each other via one or more networks. The network(s) comprise a variety of network devices, such as routers, switches, multiplexers, hubs, modems, bridges, repeaters, firewalls, proxy devices, and/or the like. The network(s) can comprise physical links, such as coaxial cable links, twisted pair cable links, fiber optic links, a combination thereof, and/or the like. The network(s) can comprise wireless links, such as cellular links, satellite links, Wi-Fi links and/or the like.

The system 100 can receive tasks from various user devices, including the user device(s) 102. Each of the tasks can include a computational task, such as to create an AIGC effect. Each of the tasks can correspond to a particular workflow among a plurality of workflows. Each workflow among the plurality of workflows can be associated with a particular business line, product, or AIGC effect. Each workflow among the plurality of workflows can include a plurality of nodes. Each node of a workflow can comprise executable code and/or machine learning model(s) that take input from the previous node and sends its output to the next node until it reaches the final node in the workflow. The output of the final node in the workflow can include the final output (e.g., the result of the task, such as an AIGC effect).

Each workflow can be used to implement multiple tasks. For example, a workflow can be used to implement two different tasks associated with the same business line, product, or AIGC effect. The two different tasks can each involve a different subset of the nodes included in that particular workflow. For example, a workflow can be used to implement both a first task associated with an AIGC effect and a second, different task associated with that same AIGC effect. The workflow can include five nodes: node A, node B, node C, node D, and node E. Execution of the first task can involve node A, node B, and node E, whereas execution of the second task can involve node C, node D, and node E.

Each node among nodes of the plurality of workflows can correspond to a particular node management component among the plurality of node management components 104a-n. Each of the plurality of node management components 104a-n can be configured to manage and implement partial execution of the plurality of tasks on the particular node. Referring back to the example described above, execution of a first task associated with an AIGC effect can involve three nodes: node A, node B, and node E. Each of node A, node B, and node E can correspond to a different node management component among the plurality of node management components 104a-n. For example, node A can correspond to node management component 104a, node B can correspond to node management component 104b, and node E can correspond to node management component 104e. The first task can be input into node A for processing, with node management component 104a managing and implementing partial execution of the first task on node A. Then, the output from node A can be input into node B for processing, with node management component 104b managing and implementing partial execution of the first task on node B. Finally, the output from node E can be input into node E for processing, with node management component 104e managing and implementing partial execution of the first task on node E.

In embodiments, the server 103 receives a task from the user device 102. In response to receiving the task, the server 103 can determine the workflow associated with the task. The server 103 can determine a path through the workflow for executing the task. For example, the path can include a first node, followed by a second node. The server 103 can send the task to a first node management component, among the plurality of node management components 104a-n, that corresponds to the first node. The first node management component can manage and implement execution of a first part of the task (e.g., the part of the task associated with the first node). For example, the first node management component can manage and implement execution of the first part of the task by the resource layer 106. In response to the resource layer 106 completing execution of the first part of the task, the resource layer 106 can send an indication (e.g., a message) of completion back to the server 103.

The server 103 can determine the next node in the path based on the workflow in response to receiving the indication of completion. For example, the server 103 can determine that the second node is the next node in the path based on the workflow. The server 103 can transfer the task to a second management component, among the plurality of node management components 104a-n, that corresponds to the second node. The second node management component can manage and implement execution of a second part of the task (e.g., the part of the task associated with the second node). For example, the second node management component can manage and implement execution of the second part of the task by the resource layer 106.

If the resource layer 106 completes execution of the second part of the task, the resource layer 106 can send an indication (e.g., a message) of completion back to the server 103. If the second node is the final node in the path based on the workflow, the server 103 can transmit a message, such as to the user device 102, indicating that the task has been successfully executed in response to receiving the indication of completion. Conversely, if the resource layer 106 does not complete execution of the second part of the task, the resource layer 106 can send to the server 103 an indication (e.g., a message) that execution of the task has not been completed. The server 103 can transmit a message, such as to the user device 102, indicating that the task has failed.

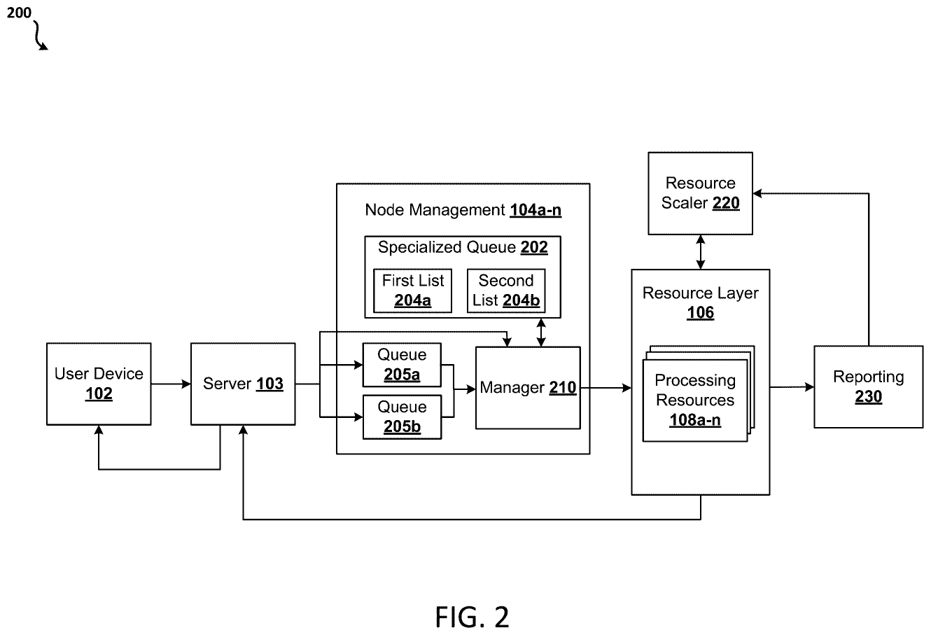

FIG. 2 shows an example system 200 for asynchronous task execution and resource management. The system 200 can include the user device 102, the server 103, the plurality of node management components 104a-n (collectively, 104), the resource layer 106 comprising the plurality of processing resources 108a-n (collectively, 108), a reporting component 230, and a resource scaler 220.

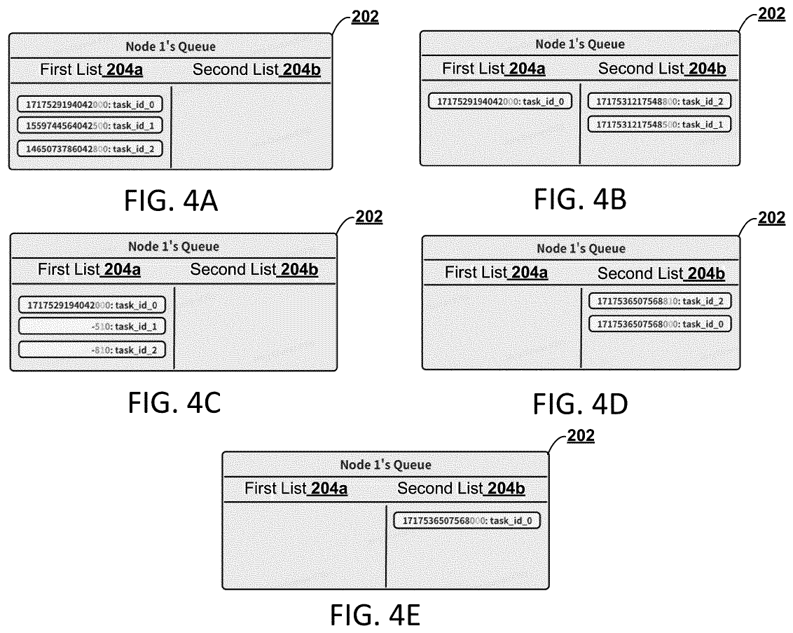

As described above with regard to FIG. 1, each node among nodes of the plurality of workflows can correspond to a particular node management component among the plurality of node management components 104a-n. Each of the plurality of node management components 104a-n can be configured to manage and implement partial execution of the plurality of tasks on the particular node. Each of the plurality of node management components 104a-n can include a specialized queue 202 corresponding to the particular node. A manager 210 of the corresponding node can use the specialized queue 202 to manage and implement partial execution of tasks on the particular node based on implementing specialized encoding of timestamp, priority, and a number of execution attempts associated with each of the tasks. Each specialized queue 202 can include a first list of tasks 204a and a second list of tasks 204b. The first list of tasks can include tasks that are waiting to be processed on the particular node. The second list of tasks 204b can include tasks that are currently being processed on the particular node. The specialized queue 202 is discussed in more detail below with regard to FIGS. 4A-E.

In embodiments, each of the plurality of node management components 104a-n can include at least one unlimited size queue, such as queue 205a and queue 205b. For example, the queue 205a can be configured to store online tasks (e.g., tasks that require processing in near real-time), while the queue 205b can be configured to store offline tasks (e.g., tasks that do not require processing in near real-time). Tasks received by a node management component can be sorted into one of the unlimited size queues before being sent to the specialized queue 202. For example, all offline tasks received by the server 103 can be sent to the queue 205b instead of being sent directly to the specialized queue 202. Because offline tasks are less urgent, they can be sent to the queue 205b to give priority to more urgent tasks. The offline tasks can remain in the queue 205b until the more urgent tasks have been completed.

The specialized queue 202 can be associated with a maximum capacity (e.g., a maximum quantity of tasks that can be stored in the specialized queue 202). If the specialized queue 202 is not full, online task(s) can be directly sent from the server 103 to the manager 210 and the specialized queue 202 for implementing partial execution of the online task(s) on the particular node. If the specialized queue 202 associated with a particular node management component is full (e.g., at maximum capacity), all tasks sent from the server 103 to that node management component can be sent to one of the unlimited size queues. For example, if the task is an online task, the task can be sent to the queue 205a. Conversely, if the task is an offline task, the task can be sent to the queue 205b. The tasks can remain in the unlimited size queue until the specialized queue 202 is no longer full.

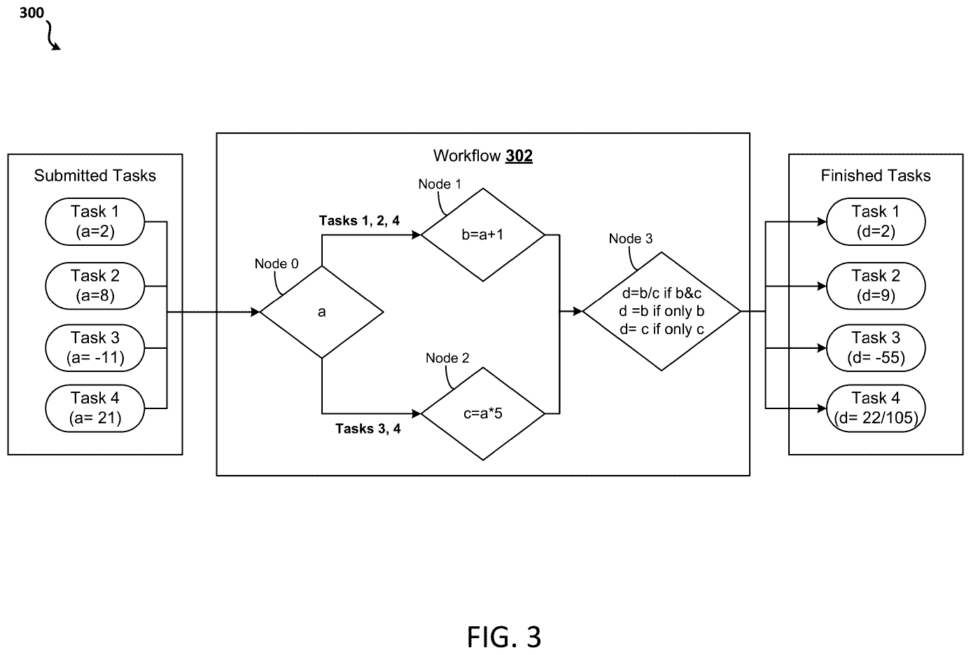

If the server 103 receives a task from the user device 102, the server 103 can determine the workflow associated with the task. For example, referring to the example system 300 of FIG. 3, the server 103 can determine that the task (e.g., task 1) corresponds to the workflow 302. The server 103 can determine a path through the workflow 302 for executing the task. The path can include three nodes: node 0, node 1, and node 3. Node 0 may be a source (e.g., non-functional) node. It should be appreciated that the server 103 can receive other tasks (e.g., task 2, task 3, task 4, etc.) corresponding to the workflow 302 from other user devices, and those other tasks can be associated with a different path through the workflow 302.

Referring back to FIG. 2, the server 103 can send the task to a first node management component, among the plurality of node management components 104a-n, that corresponds to the first node (e.g., node 1, because node 0 is a source node). The first node management component can manage and implement execution of a first part of the task (e.g., the part of the task associated with the first node). For example, the first node management component can send the task to the specialized queue 202 (or one of the unlimited size queues, if applicable) corresponding to the first node. The manager 210 corresponding to the first node can utilize the specialized queue 202 to manage and implement execution of the first part of the task by utilizing processing resource(s) in the resource layer 106. In response to the resource layer 106 completing execution of the first part of the task, the resource layer 106 can send an indication (e.g., a message) of completion back to the server 103.

The server 103 can determine the next node in the path through the workflow based on receiving the indication of completion. For example, the server 103 can determine that a second node (e.g., node 3) is the next node in the path through the workflow. The server 103 can transfer the task to a second management component, among the plurality of node management components 104a-n, that corresponds to the second node (e.g., node 3). The second node management component can manage and implement execution of a second part of the task (e.g., the part of the task associated with the second node). For example, the second node management component can send the task to the specialized queue 202 (or one of the unlimited size queues, if applicable) corresponding to the second node. The manager 210 corresponding to the second node can utilize the specialized queue 202 to manage and implement execution of the second part of the task by utilizing processing resource(s) in the resource layer 106.

In embodiments, the reporting component 230 is configured to monitor metrics of each processing resource 108 associated with each of the nodes. The reporting component 230 can monitor the metrics of each processing resource 108 to determine how many processing resources 108 are attending to each workflow node, a quantity of available processing resources 108, and/or a quantity of tasks waiting to be processed by each of the nodes. The reporting component 230 can send data indicating how many processing resources 108 are attending to each workflow node, a quantity of available processing resources 108, and/or a quantity of tasks waiting to be processed by each of the nodes to the resource scaler 220. The resource scaler 220 can use the data to scale processing resources 108 up or down for each node.

FIG. 4A-E show an example specialized queue 202. As described above, a manager 210 of a particular node can use the specialized queue 202 to manage and implement partial execution of tasks on the particular node based on implementing specialized encoding of timestamp, priority, and a number of execution attempts associated with each of the tasks. Each specialized queue 202 can include a first list of tasks 204a and a second list of tasks 204b. The first list 204a can include tasks that are waiting to be processed by the particular node. The second list 204b can include tasks that are currently being processed by the particular node.

As shown in FIG. 4A, three tasks are in the first list of tasks 204 a: task 0, task 1, and task 2. Each of the three tasks comprises a timestamp and a three-digit encoding. For example, task 0 has a timestamp of “1717529194042” and a three-digit encoding of “000,” task 1 has a timestamp of “1559744564042” and a three-digit encoding of “500,” and task 2 has a timestamp of “1465073786042” and a three-digit encoding of “800.” The first digit in the three-digit encoding indicates a priority of the task. The second digit in the three-digit encoding indicates a number of execution attempts associated with each of the tasks (e.g., a quantity of times that the resource layer 106 has attempted to execute the task). For example, if all three tasks are submitted at the same time with different priorities, task 0 can use the current time as the timestamp and “000” can be appended to the timestamp to indicate <priority=0><retry=0><0>. Task 1 and task 2 can subtract priority years from their timestamp, and the priority can be encoded within the hundreds digit.

The task(s) in the first list of tasks 204a are moved to the second list of tasks 204b based on priority order, as processing resources 108 become available to execute the task(s). For example, as shown in FIG. 4B, in response to processing resources 108 becoming available, two tasks can be moved from the first list 204a to the second list 204b. The two tasks that are moved are task 1 and task 2, because task 1 and task 2 have a higher priority level (respectively, “5” and “8”) than task 0, which has a priority level of “0 .” Once a task is started (in the example of FIG. 4B, two tasks have been started), the task gets a new timestamp corresponding to the time that the task was started. For example, task 1 and task 2 both now have a timestamp of “1717531217548.” This new timestamp is used to ensure that the node does not spend longer than a predetermined amount of time (e.g., a timeout window) to process the task. The three-digit encoding for the task can remain the same.

It can be determined whether execution of task 1 and task 2 has been completed within the predetermined amount of time. A task may not be completed within the predetermined amount of time if a transient error (e.g., a network error) occurs and/or if the processing resource 108 goes offline. As shown in FIG. 4C, if execution of task 1 has not been completed within the predetermined amount of time, and if the second digit in the three-digit encoding of task 1 indicates that a number of execution attempts associated with task 1 is not greater than a retry limit (e.g., the retry limit is one, i.e., each task can be re-tried one time), task 1 can be moved back into the first list of tasks 204a from the second list of tasks 204b. The quantity of execution attempts for task 1 can be increased by 1, causing the three-digit encoding for task 1 to be “510” instead of “500.” Moving task 1 back to the first list of tasks 204a can cause task 1 to lose its timestamp and can cause the three-digit encoding to become negative. This is because tasks that are in the first list of tasks 204a to be retried should be retried before new tasks are tried for the first time, and higher priority tasks need to have a lower value so that they are pulled from the first list of tasks 204a into the second list of tasks 204b first.

Similarly, if execution of task 2 has not been completed within the predetermined amount of time, and if the second digit in the three-digit encoding of task 2 indicates that a number of execution attempts associated with task 2 is not greater than the retry limit, task 2 can be moved back into the first list of tasks 204a from the second list of tasks 204b. The quantity of execution attempts for task 2 can be increased by 1, causing the three-digit encoding for task 2 to be “810” instead of “800.” Moving task 2 back to the first list of tasks 204a can cause task 2 to lose its timestamp and can cause the three-digit encoding to become negative.

In embodiments, a user can discard any task while that task is waiting in the specialized queue 202. For example, a user can discard task 1 while it is waiting to be retried in the first list of tasks 204a. As shown in the example of FIG. 4D, if a user discards task 1, task 1 can be removed from the specialized queue 202. In response to two processing resources 108 becoming available, two tasks can be moved from the first list of tasks 204a to the second list of tasks 204 b. The two tasks that are moved are task 0 and task 2, because task 0 and task 2 are the only remaining tasks in the first list of tasks 204 a. Once task 0 and task 2 are started, task 0 and task 2 both get a new timestamp corresponding to the time that the task was started. For example, task 0 and task 2 both now have a timestamp of “17175365075.” This new timestamp is used to ensure that the node does not spend longer than a predetermined amount of time (e.g., a timeout window) to process the task. The three-digit encoding for each task can remain the same.

It can be determined whether execution of task 0 and task 2 has been completed within the predetermined amount of time. A task may not be completed within the predetermined amount of time if a transient error (e.g., a network error) occurs and/or if the processing resource 108 goes offline. If execution of task 0 has not been completed within the predetermined amount of time, and if the second digit in the three-digit encoding of task 0 indicates that a number of execution attempts associated with task 0 is not greater than a retry limit, task 0 can be moved back into the first list of tasks 204a from the second list of tasks 204b. The quantity of execution attempts for task 0 can be increased by 1, causing the three-digit encoding for task 1 to be “010” instead of “000.” Moving task 0 back to the first list of tasks 204a can cause task 0 to lose its timestamp and can cause the three-digit encoding to become negative. On the other hand, as shown in FIG. 4E, if the re-try execution attempt of task 2 has not been completed within the predetermined amount of time and the retry limit is one, task 2 can be discarded instead of being moved back into the first list of tasks 204a and task 2 can be marked as failed.

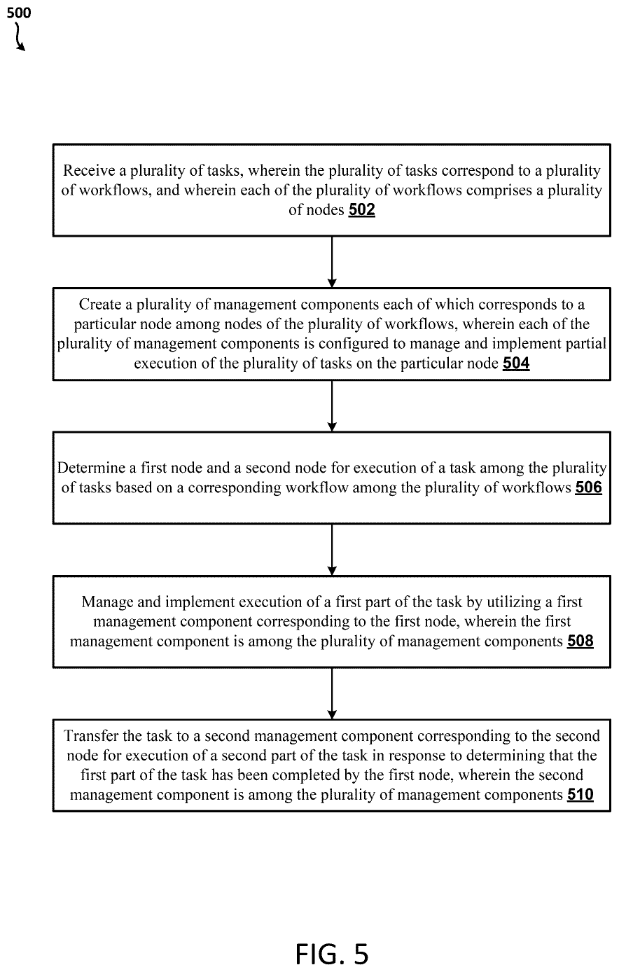

FIG. 5 shows an example process 500 for asynchronous task execution and resource management in accordance with the present disclosure. Although depicted as a sequence of operations in FIG. 5, those of ordinary skill in the art will appreciate that various embodiments can add, remove, reorder, or modify the depicted operations.

At 502, a plurality of tasks can be received (e. g, from various user devices). Each of the tasks can include a computational task, such as to create an AIGC effect. The plurality of tasks can correspond to a plurality of workflows. Each of the tasks can correspond to a particular workflow among a plurality of workflows. Each workflow among of the plurality of workflows can be associated with a particular business line, product, or AIGC effect. Each of the plurality of workflows can include a plurality of nodes. For example, each workflow among the plurality of workflows can be represented by a directed acyclic graph, and each node (e.g., vertex) can comprise executable code and/or a machine learning model that takes input from the previous node and sends its output to the next node until it reaches the final node in the workflow. The output of the final node can include the final output (e.g., the result of the task, such as an AIGC effect). Each workflow can be used to implement multiple tasks. For example, a workflow can be used to implement two different tasks associated with the same business line, product, or AIGC effect. The two different tasks can each involve a different subset of the nodes included in that particular workflow.

At 504, a plurality of management components (e.g., plurality of node management components 104a-n) can be created. Each of the plurality of management components can correspond to a particular node among nodes of the plurality of workflows. Each of the plurality of management components can be configured to manage and implement partial execution of the plurality of tasks on the particular node.

At 506, a first node and a second node for execution of a task among the plurality of tasks can be determined. The first node and the second node can be determined based on a workflow (e.g., workflow 302), among the plurality of workflows, that corresponds to the task. The task can be sent to a first management component, among the plurality of management components, that corresponds to the first node. At 508, execution of a first part of the task (e.g., the part of the task associated with the first node) can be managed by the first management component. For example, execution of the first part of the task by a resource layer (e.g., resource layer 106) can be managed and implemented by the first management component. In response to determining that the first part of the task has been completed on the first node, the task can be transferred to a second management component, among the plurality of management components, that corresponds to the second node. At 510, the task can be transferred to the second management component for execution of a second part of the task (e.g., the part of the task associated with the second node).

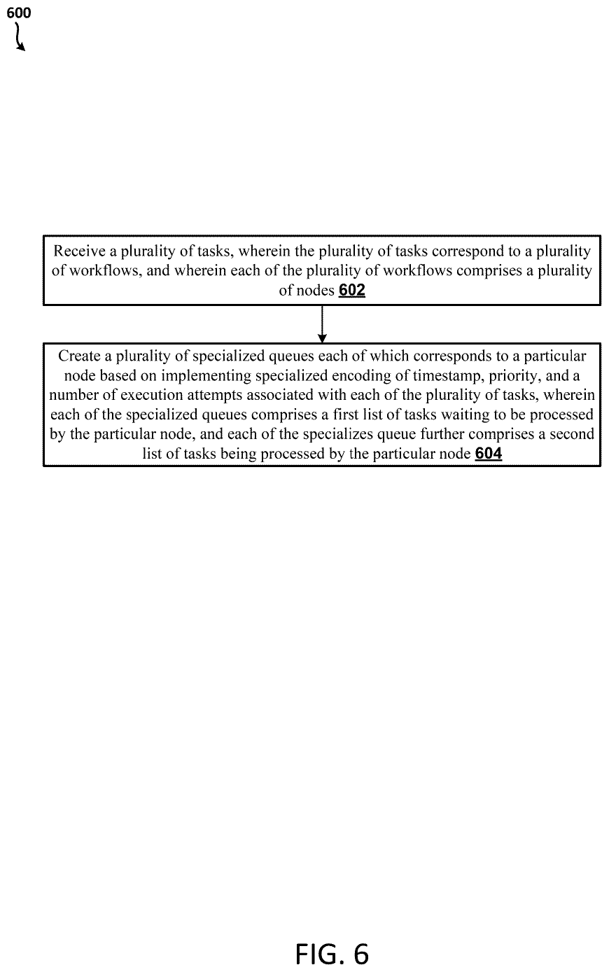

FIG. 6 shows an example process 600 for creating specialized queues in accordance with the present disclosure. Although depicted as a sequence of operations in FIG. 6, those of ordinary skill in the art will appreciate that various embodiments can add, remove, reorder, or modify the depicted operations.

At 602, a plurality of tasks can be received (e. g, from various user devices). Each of the tasks can include a task to perform a computational task, such as to create an AIGC effect. The plurality of tasks can correspond to a plurality of workflows. Each of the tasks can correspond to a particular workflow among a plurality of workflows. Each of the plurality of workflows can include a plurality of nodes. For example, each workflow among the plurality of workflows can be represented by a directed acyclic graph, and each node (e.g., vertex) can comprise executable code and/or machine learning model(s) that take input from the previous node(s) and send output to the next nodes until it reaches the final node in the workflow. The output of the final node in the graph can include the final output (e.g., the result of the task, such as an AIGC effect).

A plurality of management components (e.g., plurality of node management components 104a-n) can be created. Each of the plurality of management components can correspond to a particular node among nodes of the plurality of workflows. Each of the plurality of management components can be configured to manage and implement partial execution of the plurality of tasks on the particular node. Each of the plurality of node management components can include a specialized queue (e.g., specialized queue 202) corresponding to the particular node. At 604, a plurality of specialized queues can be created based on implementing specialized encoding of timestamp, priority, and a number of execution attempts associated with each of the plurality of tasks. Each of the specialized queues comprises a first list of tasks (e.g., first list of tasks 204a) waiting to be processed by the particular node, and a second list of tasks (e.g., first list of tasks 204b) being processed by the particular node.

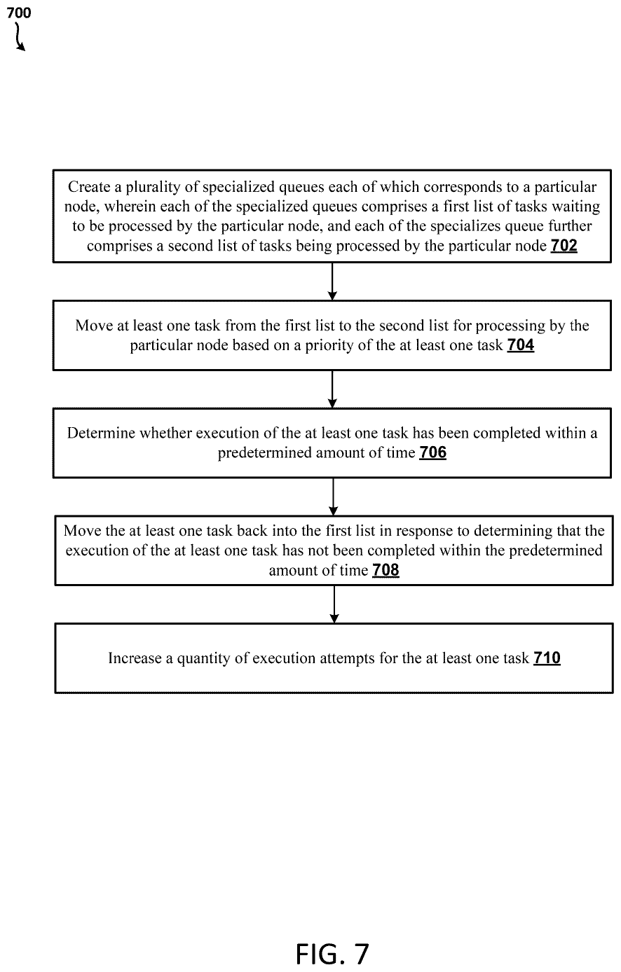

FIG. 7 shows an example process 700 for asynchronous task execution in accordance with the present disclosure. Although depicted as a sequence of operations in FIG. 7, those of ordinary skill in the art will appreciate that various embodiments can add, remove, reorder, or modify the depicted operations.

A plurality of management components (e.g., plurality of node management components 104a-n) can be created. Each of the plurality of management components can correspond to a particular node among nodes of a plurality of workflows. Each of the plurality of management components can be configured to manage and implement partial execution of the plurality of tasks on the particular node. Each of the plurality of node management components can include a specialized queue (e.g., specialized queue 202) corresponding to the particular node. At 702, a plurality of specialized queues can be created based on implementing specialized encoding of timestamp, priority, and a number of execution attempts associated with each of the plurality of tasks. Each of the specialized queues comprises a first list of tasks (e.g., first list of tasks 204a) waiting to be processed by the particular node, and a second list of tasks (e.g., first list of tasks 204b) being processed by the particular node. At 704, at least one task can be moved from the first list to the second list for processing by the particular node based on a priority of the at least one task. For example, the at least one task can be moved from the first list to the second list for processing based on determining that the at least one task is associated with a highest priority as compared to other tasks in the first list.

At 706, it can be determined whether execution of the at least one task has been completed within a predetermined amount of time. At 708, the at least one task can be moved back into the first list in response to determining that the execution of the at least one task has not been completed within the predetermined amount of time. At 710, a quantity of execution attempts for the at least one task can be increased. The quantity of execution attempts for the at least one task can be increased in response to determining that the at least one task has not been successfully completed.

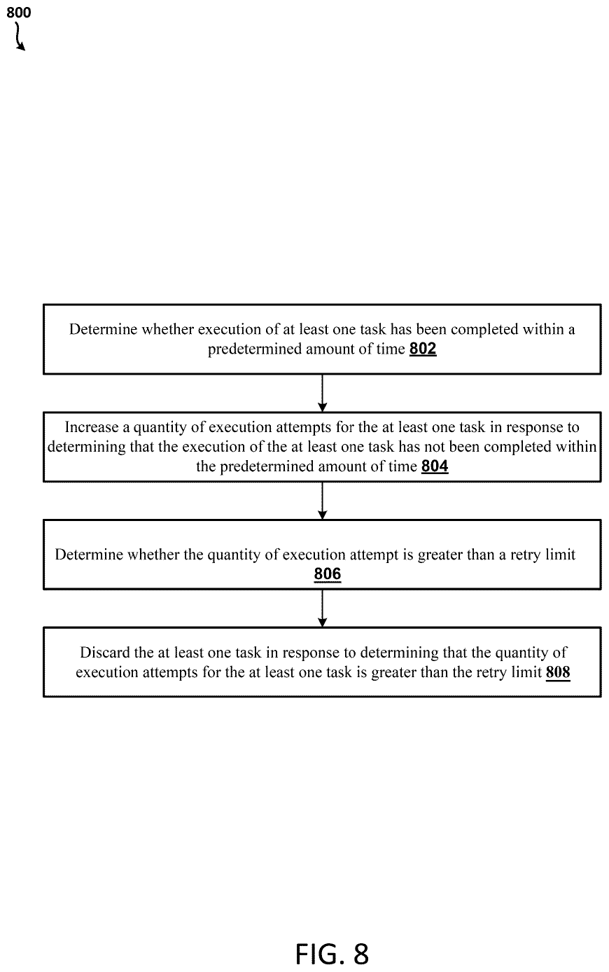

FIG. 8 shows an example process 800 for asynchronous task execution in accordance with the present disclosure. Although depicted as a sequence of operations in FIG. 8, those of ordinary skill in the art will appreciate that various embodiments can add, remove, reorder, or modify the depicted operations.

A plurality of management components (e.g., plurality of node management components 104a-n) can be created. Each of the plurality of management components can correspond to a particular node among nodes of the plurality of workflows. Each of the plurality of management components can be configured to manage and implement partial execution of the plurality of tasks on the particular node. Each of the plurality of node management components can include a specialized queue (e.g., specialized queue 202) corresponding to the particular node. Each specialized queue can include a first list of tasks (e.g., first list of tasks 204a) and a second list of tasks (e.g., second list of tasks 204b). The first list of tasks can include tasks that are waiting to be processed on the particular node. The second list of tasks can include tasks that are currently being processed on the particular node. The task(s) in the first list of tasks are moved to the second list of tasks based on priority order, as processing resources (e.g., processing resources 108) become available to execute the task(s). For example, in response to at least one processing resource becoming available, at least one task can be moved from the first list to the second list. Once the at least one task is started for processing, the at least one task gets a new timestamp corresponding to the time that the task was started for processing. This new timestamp can be used to ensure that the particular node does not spend longer than a predetermined amount of time (e.g., a timeout window) to process the task.

At 802, it can be determined whether execution of at least one task has been completed on a particular node within the predetermined amount of time. The at least one task may not be completed within the predetermined amount of time if a transient error (e.g., a network error) occurs and/or if the processing resource goes offline. At 804, a quantity of execution attempt for the at least one task can be increased in response to determining that the execution of the at least one task has not been completed within the predetermined amount of time. At 806, it can be determined whether the quantity of execution attempt is greater than a retry limit (e.g., if the retry limit is one, each task can be re-tried one time). Execution of the at least one task can be re-tried a quantity of time that is equal to the retry limit. At 808, the at least one task can be discarded. For example, the at least one task can be discarded from a management component corresponding to the particular node. In response to determining that the quantity of execution attempt for the at least one task is greater than the retry limit, the at least one task can be discarded and the at least one task can be marked as failed.

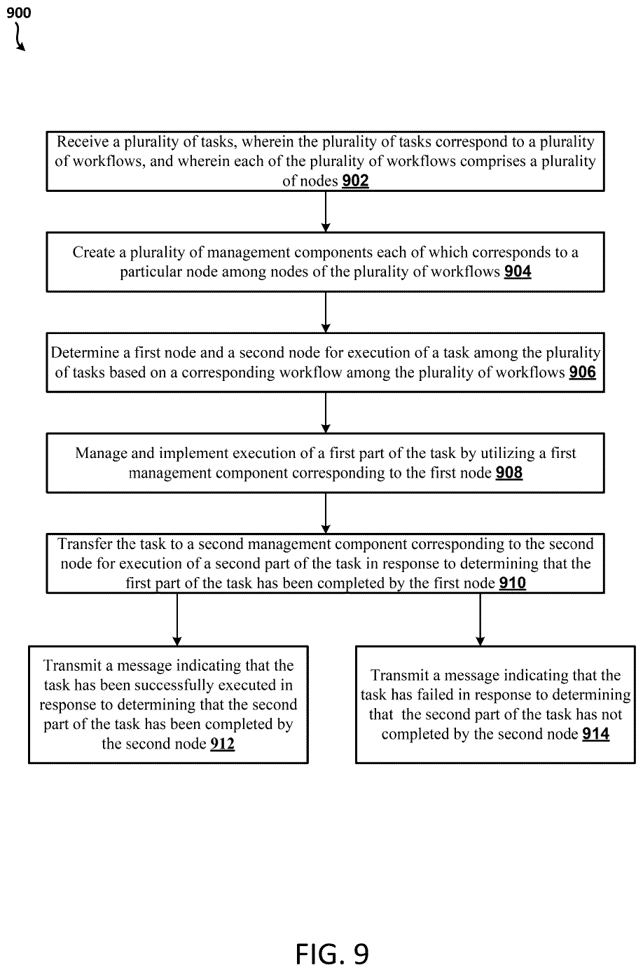

FIG. 9 shows an example process 900 for asynchronous task execution and resource management in accordance with the present disclosure. Although depicted as a sequence of operations in FIG. 9, those of ordinary skill in the art will appreciate that various embodiments can add, remove, reorder, or modify the depicted operations.

At 902, a plurality of tasks can be received (e. g, from various user devices). Each of the tasks can include a task to perform a computational task, such as to create an AIGC effect. The plurality of tasks can correspond to a plurality of workflows. Each of the tasks can correspond to a particular workflow among a plurality of workflows. Each of the plurality of workflows can include a plurality of nodes. For example, each workflow among the plurality of workflows can be represented by a directed acyclic graph, and each node (e.g., vertex) can comprise executable code and/or machine learning model(s) that take input from the previous node(s) and send output to the next nodes until it reaches the final node in the graph. The output of the final node in the graph can include the final output (e.g., the result of the task, such as an AIGC effect).

At 904, a plurality of management components (e.g., plurality of node management components 104a-n) can be created. Each of the plurality of management components can correspond to a particular node among nodes of the plurality of workflows. Each of the plurality of management components can be configured to manage and implement partial execution of the plurality of tasks on the particular node.

At 906, a first node and a second node for execution of a task among the plurality of tasks can be determined. The first node and the second node can be determined based on a workflow (e.g., workflow 302), among the plurality of workflows, that corresponds to the task. The task can be sent to a first management component, among the plurality of management components, that corresponds to the first node. At 908, execution of a first part of the task (e.g., the part of the task associated with the first node) can be managed and implemented by the first management component. For example, execution of the first part of the task by a resource layer (e.g., resource layer 106) can be managed and implemented by the first management component. In response to determining that the first part of the task has been completed by the first node, the task can be transferred to a second management component, among the plurality of management components, that corresponds to the second node. At 910, the task can be transferred to the second management component for managing execution of a second part of the task (e.g., the part of the task associated with the second node).

At 912, a message indicating that the task has been successfully executed can be sent. The message can be sent, for example, to the user device that requested execution of the task. The message indicating that the task has been successfully executed can be sent in response to determining that the second part of the task has been successfully completed by the second node. Alternatively, at 914, a message indicating that the task has failed can be sent. The message can be sent, for example, to the user device that requested execution of the task. The message indicating that the task has failed can be sent in response to determining that the second part of the task has not successfully completed by the second node.

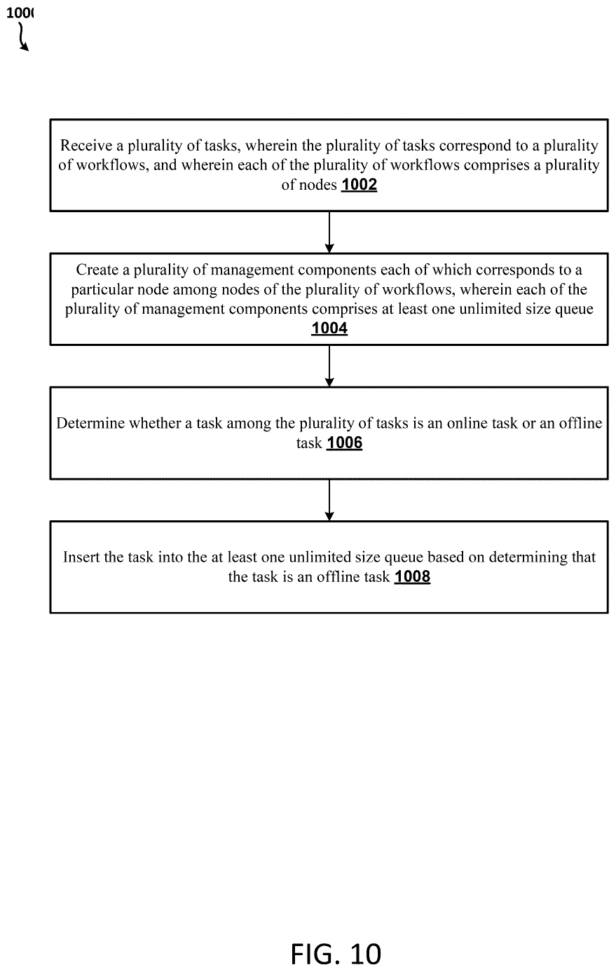

FIG. 10 shows an example process 1000 for resource management in accordance with the present disclosure. Although depicted as a sequence of operations in FIG. 10, those of ordinary skill in the art will appreciate that various embodiments can add, remove, reorder, or modify the depicted operations.

At 1002, a plurality of tasks can be received (e. g, from various user devices). Each of the tasks can include a task to perform a computational task, such as to create an AIGC effect. The plurality of tasks can correspond to a plurality of workflows. Each of the tasks can correspond to a particular workflow among a plurality of workflows. Each of the plurality of workflows can include a plurality of nodes. For example, each workflow among the plurality of workflows can be represented by a directed acyclic graph, and each node (e.g., vertex) can comprise executable code and/or a machine learning model that takes input from the previous node and sends its output to the next node until it reaches the final node in the graph. The output of the final node in the graph can include the final output (e.g., the result of the task, such as an AIGC effect).

At 1004, a plurality of management components (e.g., plurality of node management components 104a-n) can be created. Each of the plurality of management components can correspond to a particular node among nodes of the plurality of workflows. Each of the plurality of management components can be configured to manage partial execution of the plurality of tasks on the particular node. Each of the plurality of management components can include at least one unlimited size queue (e.g., queue 205a and/or queue 205b). At 1006, it can be determined whether a task among the plurality of tasks is an online task (e.g., a task that requires processing in near real-time) or an offline task (e.g., a task that does not require processing in near real-time). At 1008, the task can be inserted into the at least one unlimited size queue based on determining that the task is an offline task.

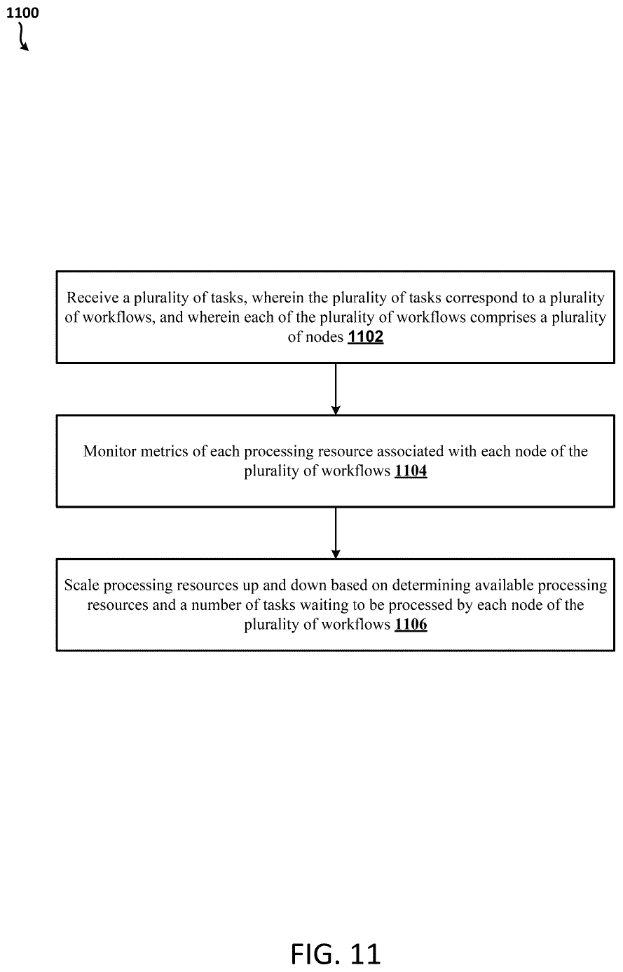

FIG. 11 shows an example process 1100 for resource management in accordance with the present disclosure. Although depicted as a sequence of operations in FIG. 11, those of ordinary skill in the art will appreciate that various embodiments can add, remove, reorder, or modify the depicted operations.

At 1102, a plurality of tasks can be received (e. g, from various user devices). Each of the tasks can include a computational task, such as to create an AIGC effect. The plurality of tasks can correspond to a plurality of workflows. Each of the tasks can correspond to a particular workflow among a plurality of workflows. Each of the plurality of workflows can include a plurality of nodes. For example, each workflow among the plurality of workflows can be represented by a directed acyclic graph, and each node (e.g., vertex) can comprise executable code and/or a machine learning model that takes input from the previous node and sends its output to the next node until it reaches the final node in the graph. The output of the final node in the graph can include the final output (e.g., the result of the task, such as an AIGC effect).

At 1104, metrics of each processing resource (e.g., processing resources 108) associated with each of the nodes of the plurality of workflows can be monitored. The metrics can indicate how many processing resources are attending to each node, a quantity of available processing resources, and/or a quantity of tasks waiting to be processed by each of the nodes of the plurality of workflows. At 1106, processing resources can be scaled up and down based on determining the available processing resources and/or the number of tasks waiting to be processed by each node of the plurality of workflows.

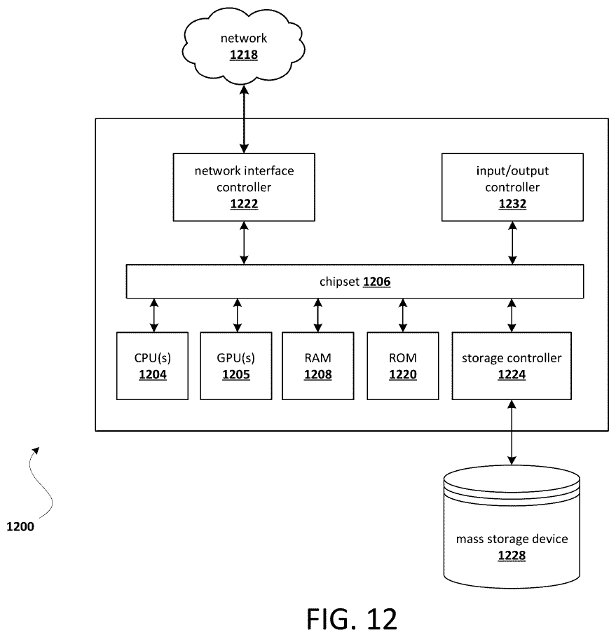

FIG. 12 illustrates a computing device that can be used in various aspects, such as the model(s), components, and/or devices depicted in FIGS. 1-4. With regard to FIGS. 1-4, any or all of the components can each be implemented by one or more instance of a computing device 1200 of FIG. 12. The computer architecture shown in FIG. 12 shows a conventional server computer, workstation, desktop computer, laptop, tablet, network appliance, PDA, e-reader, digital cellular phone, or other computing node, and can be utilized to execute any aspects of the computers described herein, such as to implement the methods described herein.

The computing device 1200 can include a baseboard, or “motherboard,” which is a printed circuit board to which a multitude of components or devices can be connected by way of a system bus or other electrical communication paths. One or more central processing units (CPUs) 1204 can operate in conjunction with a chipset 1206. The CPU(s) 1204 can be standard programmable processors that perform arithmetic and logical operations necessary for the operation of the computing device 1200.

The CPU(s) 1204 can perform the necessary operations by transitioning from one discrete physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits including registers, adders-subtractors, arithmetic logic units, floating-point units, and the like.

The CPU(s) 1204 can be augmented with or replaced by other processing units, such as GPU(s) 1205. The GPU(s) 1205 can comprise processing units specialized for but not necessarily limited to highly parallel computations, such as graphics and other visualization-related processing.

A chipset 1206 can provide an interface between the CPU(s) 1204 and the remainder of the components and devices on the baseboard. The chipset 1206 can provide an interface to a random-access memory (RAM) 1208 used as the main memory in the computing device 1200. The chipset 1206 can further provide an interface to a computer-readable storage medium, such as a read-only memory (ROM) 1220 or non-volatile RAM (NVRAM) (not shown), for storing basic routines that can help to start up the computing device 1200 and to transfer information between the various components and devices. ROM 1220 or NVRAM can also store other software components necessary for the operation of the computing device 1200 in accordance with the aspects described herein.

The computing device 1200 can operate in a networked environment using logical connections to remote computing nodes and computer systems through local area network (LAN). The chipset 1206 can include functionality for providing network connectivity through a network interface controller (NIC) 1222, such as a gigabit Ethernet adapter. A NIC 1222 can be capable of connecting the computing device 1200 to other computing nodes over a network 1218. It should be appreciated that multiple NICs 1222 can be present in the computing device 1200, connecting the computing device to other types of networks and remote computer systems.

The computing device 1200 can be connected to a mass storage device 1228 that provides non-volatile storage for the computer. The mass storage device 1228 can store system programs, application programs, other program modules, and data, which have been described in greater detail herein. The mass storage device 1228 can be connected to the computing device 1200 through a storage controller 1224 connected to the chipset 1206. The mass storage device 1228 can consist of one or more physical storage units. The mass storage device 1228 can comprise a management component 1210. A storage controller 1224 can interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1200 can store data on the mass storage device 1228 by transforming the physical state of the physical storage units to reflect the information being stored. The specific transformation of a physical state can depend on various factors and on different implementations of this description. Examples of such factors can include, but are not limited to, the technology used to implement the physical storage units and whether the mass storage device 1228 is characterized as primary or secondary storage and the like.

For example, the computing device 1200 can store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 can further read information from the mass storage device 1228 by detecting the physical states or characteristics of one or more particular locations within the physical storage units.

In addition to the mass storage device 1228 described above, the computing device 1200 can have access to other computer-readable storage media to store and retrieve information, such as program modules, data structures, or other data. It should be appreciated by those skilled in the art that computer-readable storage media can be any available media that provides for the storage of non-transitory data and that can be accessed by the computing device 1200.

By way of example and not limitation, computer-readable storage media can include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that can be used to store the desired information in a non-transitory fashion.

A mass storage device, such as the mass storage device 1228 depicted in FIG. 12, can store an operating system utilized to control the operation of the computing device 1200. The operating system can comprise a version of the LINUX operating system. The operating system can comprise a version of the WINDOWS SERVER operating system from the MICROSOFT Corporation. According to further aspects, the operating system can comprise a version of the UNIX operating system. Various mobile phone operating systems, such as IOS and ANDROID, can also be utilized. It should be appreciated that other operating systems can also be utilized. The mass storage device 12228 can store other system or application programs and data utilized by the computing device 1200.

The mass storage device 1228 or other computer-readable storage media can also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described above. The computing device 1200 can have access to computer-readable storage media storing computer-executable instructions, which, when executed by the computing device 1200, can perform the methods described herein.

A computing device, such as the computing device 1200 depicted in FIG. 12, can also include an input/output controller 1232 for receiving and processing input from a number of input devices, such as a keyboard, a mouse, a touchpad, a touch screen, an electronic stylus, or other type of input device. Similarly, an input/output controller 1232 can provide output to a display, such as a computer monitor, a flat-panel display, a digital projector, a printer, a plotter, or other type of output device. It will be appreciated that the computing device 1200 can not include all of the components shown in FIG. 12, can include other components that are not explicitly shown in FIG. 12, or can utilize an architecture completely different than that shown in FIG. 12.

As described herein, a computing device can be a physical computing device, such as the computing device 1200 of FIG. 12. A computing node can also include a virtual machine host process and one or more virtual machine instances. Computer-executable instructions can be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance can or can not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that can be used to perform the described methods and systems. When combinations, subsets, interactions, groups, etc., of these components are described, it is understood that while specific references to each of the various individual and collective combinations and permutations of these can not be explicitly described, each is specifically contemplated and described herein, for all methods and systems. This applies to all aspects of this application including, but not limited to, operations in described methods. Thus, if there are a variety of additional operations that can be performed it is understood that each of these additional operations can be performed with any specific embodiment or combination of embodiments of the described methods.

The present methods and systems can be understood more readily by reference to the following detailed description of preferred embodiments and the examples included therein and to the Figures and their descriptions.

As will be appreciated by one skilled in the art, the methods and systems can take the form of an entirely hardware embodiment, an entirely software embodiment, or an embodiment combining software and hardware aspects. Furthermore, the methods and systems can take the form of a computer program product on a computer-readable storage medium having computer-readable program instructions (e.g., computer software) embodied in the storage medium. More particularly, the present methods and systems can take the form of web-implemented computer software. Any suitable computer-readable storage medium can be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, can be implemented by computer program instructions. These computer program instructions can be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions can also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above can be used independently of one another or can be combined in various ways. All possible combinations and sub-combinations are intended to fall within the scope of this disclosure. In addition, certain methods or process blocks can be omitted in some implementations. The methods and processes described herein are also not limited to any particular sequence, and the blocks or states relating thereto can be performed in other sequences that are appropriate. For example, described blocks or states can be performed in an order other than that specifically described, or multiple blocks or states can be combined in a single block or state. The example blocks or states can be performed in serial, in parallel, or in some other manner. Blocks or states can be added to or removed from the described example embodiments. The example systems and components described herein can be configured differently than described. For example, elements can be added to, removed from, or rearranged compared to the described example embodiments.

It will also be appreciated that various items are illustrated as being stored in memory or on storage while being used, and that these items or portions thereof can be transferred between memory and other storage devices for purposes of memory management and data integrity. Alternatively, in other embodiments, some or all of the software modules and/or systems can execute in memory on another device and communicate with the illustrated computing systems via inter-computer communication. Furthermore, in some embodiments, some or all of the systems and/or modules can be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures can also be stored (e.g., as software instructions or structured data) on a computer-readable medium, such as a hard disk, a memory, a network, or a portable media article to be read by an appropriate device or via an appropriate connection. The systems, modules, and data structures can also be transmitted as generated data signals (e.g., as part of a carrier wave or other analog or digital propagated signal) on a variety of computer-readable transmission media, including wireless-based and wired/cable-based media, and can take a variety of forms (e.g., as part of a single or multiplexed analog signal, or as multiple discrete digital packets or frames). Such computer program products can also take other forms in other embodiments. Accordingly, the present invention can be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations can be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method for task execution, comprising:
receiving a plurality of tasks, wherein the plurality of tasks correspond to a plurality of workflows, and wherein each of the plurality of workflows comprises a plurality of nodes;
creating a plurality of management components each of which corresponds to a particular node among nodes of the plurality of workflows, wherein each of the plurality of management components is configured to manage and implement partial execution of the plurality of tasks on the particular node;
determining a first node and a second node for execution of a task among the plurality of tasks based on a corresponding workflow among the plurality of workflows;
managing and implementing execution of a first part of the task by utilizing a first management component corresponding to the first node, wherein the first management component is among the plurality of management components; and
transferring the task to a second management component corresponding to the second node for execution of a second part of the task in response to determining that the first part of the task has been completed by the first node, wherein the second management component is among the plurality of management components.

2. The method of claim 1, wherein the creating a plurality of management components each of which corresponds to a particular node further comprises:
creating a plurality of specialized queues each of which corresponds to the particular node based on implementing specialized encoding of timestamp, priority, and a number of execution attempts associated with each of the plurality of tasks.

3. The method of claim 2, wherein each of the specialized queue comprises a first list of tasks waiting to be processed by the particular node, and each of the specializes queue further comprises a second list of tasks being processed by the particular node.

4. The method of claim 3, further comprising:
moving at least one task from the first list to the second list for processing by the particular node based on a priority of the at least one task; and
determining whether execution of the at least one task has been completed within a predetermined amount of time.

5. The method of claim 4, further comprising:
moving the at least one task into the first list in response to determining that the execution of the at least one task has not been completed within the predetermined amount of time; and
increasing a quantity of execution attempts for the at least one task.

6. The method of claim 5, further comprising:
determining whether the quantity of execution attempt is greater than a retry limit; and
discarding the at least one task in response to determining that the quantity of execution attempts for the at least one task is greater than the retry limit.

7. The method of claim 1, further comprising:
transmitting a message indicating that the task has been successfully executed in response to determining that the second part of the task has been completed by the second node; or
transmitting a message indicating that the task has failed in response to determining that the second part of the task has not completed by the second node.

8. The method of claim 1, wherein each of the plurality of management components comprises at least one unlimited size queue, and wherein the method further comprises:
determining whether the task is an online task or an offline task; and
inserting the task into the at least one unlimited size queue based on determining that the task is an offline task.

9. The method of claim 1, further comprising:
monitoring metrics of each processing resource associated with each of the nodes of the plurality of workflows; and
scaling processing resources up and down based on determining available processing resources and a number of tasks waiting to be processed by each of the nodes of the plurality of workflows.

10. A system of task execution, comprising:
at least one processor; and
at least one memory communicatively coupled to the at least one processor and comprising computer-readable instructions that upon execution by the at least one processor cause the at least one processor to perform operations comprising:
receiving a plurality of tasks, wherein the plurality of tasks correspond to a plurality of workflows, and wherein each of the plurality of workflows comprises a plurality of nodes;
creating a plurality of management components each of which corresponds to a particular node among nodes of the plurality of workflows, wherein each of the plurality of management components is configured to manage and implement partial execution of the plurality of tasks on the particular node;
determining a first node and a second node for execution of a task among the plurality of tasks based on a corresponding workflow among the plurality of workflows;
managing and implementing execution of a first part of the task by utilizing a first management component corresponding to the first node, wherein the first management component is among the plurality of management components; and
transferring the task to a second management component corresponding to the second node for execution of a second part of the task in response to determining that the first part of the task has been completed by the first node, wherein the second management component is among the plurality of management components.

11. The system of claim 10, wherein the creating a plurality of management components each of which corresponds to a particular node further comprises:
creating a plurality of specialized queues each of which corresponds to the particular node based on implementing specialized encoding of timestamp, priority, and a number of execution attempts associated with each of the plurality of tasks, wherein each of the specialized queue comprises a first list of tasks waiting to be processed by the particular node, and each of the specializes queue further comprises a second list of tasks being processed by the particular node.

12. The system of claim 11, the operations further comprising:
moving at least one task from the first list to the second list for processing by the particular node based on a priority of the at least one task; and
determining whether execution of the at least one task has been completed within a predetermined amount of time.

13. The system of claim 12, the operations further comprising:
moving the at least one task into the first list in response to determining that the execution of the at least one task has not been completed within the predetermined amount of time; and
increasing a quantity of execution attempts for the at least one task.

14. The system of claim 13, the operations further comprising:
determining whether the quantity of execution attempt is greater than a retry limit; and
discarding the at least one task in response to determining that the quantity of execution attempts for the at least one task is greater than the retry limit.

15. The system of claim 10, the operations further comprising:
monitoring metrics of each processing resource associated with each of the nodes of the plurality of workflows; and
scaling processing resources up and down based on determining available processing resources and a number of tasks waiting to be processed by each of the nodes of the plurality of workflows.

16. A non-transitory computer-readable storage medium, storing computer-readable instructions that upon execution by a processor cause the processor to implement operations comprising:
receiving a plurality of tasks, wherein the plurality of tasks correspond to a plurality of workflows, and wherein each of the plurality of workflows comprises a plurality of nodes;
creating a plurality of management components each of which corresponds to a particular node among nodes of the plurality of workflows, wherein each of the plurality of management components is configured to manage and implement partial execution of the plurality of tasks on the particular node;
determining a first node and a second node for execution of a task among the plurality of tasks based on a corresponding workflow among the plurality of workflows;
managing and implementing execution of a first part of the task by utilizing a first management component corresponding to the first node, wherein the first management component is among the plurality of management components; and
transferring the task to a second management component corresponding to the second node for execution of a second part of the task in response to determining that the first part of the task has been completed by the first node, wherein the second management component is among the plurality of management components.

17. The non-transitory computer-readable storage medium of claim 16, wherein the creating a plurality of management components each of which corresponds to a particular node further comprises:
creating a plurality of specialized queues each of which corresponds to the particular node based on implementing specialized encoding of timestamp, priority, and a number of execution attempts associated with each of the plurality of tasks, wherein each of the specialized queue comprises a first list of tasks waiting to be processed by the particular node, and each of the specializes queue further comprises a second list of tasks being processed by the particular node.

18. The non-transitory computer-readable storage medium of claim 17, the operations further comprising:
moving at least one task from the first list to the second list for processing by the particular node based on a priority of the at least one task; and
determining whether execution of the at least one task has been completed within a predetermined amount of time.

19. The non-transitory computer-readable storage medium of claim 18, the operations further comprising:
moving the at least one task into the first list in response to determining that the execution of the at least one task has not been completed within the predetermined amount of time; and
increasing a quantity of execution attempts for the at least one task.

20. The non-transitory computer-readable storage medium of claim 19, the operations further comprising:
determining whether the quantity of execution attempt is greater than a retry limit; and
discarding the at least one task in response to determining that the quantity of execution attempts for the at least one task is greater than the retry limit.
